(19) United States
(12) Patent Application Publication
(10) Pub. No.: US 2026/0276431 A1
(43) Pub. Date: Sep. 17, 2026

(54) CARRIER AND/OR FORK BOARD WITH WEIGHT MEASUREMENT FOR A LIFTING DEVICE, LIFTING DEVICE PROVIDED THEREWITH AND METHOD THEREFOR

(71) Applicant: MEIJER HOLDING B.V., Sint Jacobiparochie (NL)

(72) Inventor: Hendrik Meijer, Sint Jacobiparochie (NL)

(21) Appl. No.: 19/164,071

(22) PCT Filed: Mar. 14, 2024
(86) PCT No.: PCT/NL2024/050128

§ 371 Date: Sep. 10, 2025

(30) Foreign Application Priority Data
Mar. 14, 2023 (NL) 2034337
Apr. 11, 2023 (NL) 2034532
Feb. 14, 2024 (NL) 2037027

(51) Int. Cl. G01G 3/12; B66F 9/12; B66F 17/00; G01G 23/32

(52) U.S. Cl. CPC G01G 3/125; B66F 9/12; B66F 17/003; G01G 23/32

(57) ABSTRACT

The invention relates to a carrier for loads, such as a fork for a lifting device, and a fork board and/or lifting device provided with such a carrier and associated method. The carrier according to the invention comprises:—coupling means configured to couple the carrier to the lifting device;—a carrier part for carrying loads,—an optical fiber cable arranged in or on the carrier part; and—an optical fiber controller which is operatively connectable to the optical fiber cable and is configured to perform a measurement with the optical fiber cable, such that the weight of the load or loads on the carrier can be determined.

The invention relates to a carrier with which a weight measurement of the load or loads on the carrier can be carried out. Such a carrier for instance relates to a fork of a fork-lift truck or pallet truck. Such carriers are used for picking up, displacing and setting down loads.

Lifting devices are known in practice in the form of for instance fork-lift trucks and pallet trucks. Such fork-lift trucks and pallet trucks are provided with forks which function as carriers, such as for instance described in NL 2018218. Also known in practice are weighing forks with which it is possible to measure the weight of loads on a fork of for instance a fork-lift truck. Such weighing forks known in practice make use of so-called load cells. A problem in application of load cells is that they are arranged in a recess arranged in the carrier part of the fork. This usually requires milling of such a recess. This results in weakening of the carrier, this reducing the load-bearing capacity. What's more, an additional operation must be performed on such a fork, which increases the cost of such a weighing fork.

The present invention has for its object to provide a carrier, such as a fork for a fork-lift truck or pallet truck, whereby the above stated problems are obviated or at least reduced, such that a measurement of the weight of a load or loads on such a carrier can be carried out in effective manner.

This object is achieved with the carrier, such as a fork for a lifting device, according to the invention, wherein the carrier comprises:
coupling means configured to couple the carrier to the lifting device;
a carrier part for carrying loads,
an optical fiber cable arranged in or on the carrier part; and
an optical fiber controller which is operatively connectable to the optical fiber cable and is configured to perform a measurement with the optical fiber cable, such that the weight of the load or loads on the carrier can be determined.

Said lifting device is particularly a fork-lift truck. In addition, such a lifting device can also relate to a pallet truck, AGV, and to other lifting devices. The fork-lift truck can for instance be a mast fork-lift truck or truck-mounted fork-lift truck. A carrier can additionally be applied for automated warehouses, a coil boom for for instance steel rolls and carpet rolls, and crane arms. The carrier can be provided as a separate component and be mounted releasably on for instance a fork board of a lifting device or a fork adjuster thereof, or be fixedly connected to a lifting device.

De carrier according to the invention is provided with coupling means whereby the carrier can be connected to the lifting device. The carrier part of the carrier is configured to carry the load or loads which can be picked up, displaced and be set down with the carrier.

Further arranged in or on the carrier part is an optical fiber cable which is operatively connectable to an optical fiber controller configured to perform a measurement with the optical fiber cable, such that the weight of the load or loads on the carrier can be determined. The optical fiber cable enables an optical measurement, such that no conventional current/voltage signal need be carried through a cable. This significantly reduces the risk of disruptions of the signal transmitted through the optical fiber cable. This results in a greater reliability and accuracy of the measurement. The optical fiber cable is preferably provided with one or more measuring points, for instance by providing a small notch at the position of a measuring point, in order to thereby be able to determine a distortion of the optical signal sent through the optical fiber cable as a result of a load at this position. From the return signal of the (possibly) distorted optical (input) signal it is possible to perform a weight measurement such that the weight of the load or loads on the carrier can be determined. In order to perform a measurement the optical fiber controller is in a currently preferred embodiment provided with a (so-called) interrogator for emitting such optical signals for the purpose of the measurement, and for receiving the return signals. In such a preferred embodiment the interrogator passes the obtained measurement signals on to the software configured to determine the actual load, and optionally to determine follow-up actions on the basis of the measurement, such as an alarm in the event of an overload. For performing a measurement use can be made of a so-called fiber Bragg grating. The software can be provided in the optical fiber controller and/or can be provided at a different location, for instance in the cab of the lifting device such as a fork-lift truck, on an external device such as a tablet, telephone, watch and/or in a central control system, for instance in a control room for an operator.

A further advantage of performing a weight measurement using the optical fiber cable and the carrier according to the invention is that the measurement can be performed robustly in time. This means that there is no so-called drift of the measurement in time. This results in a reliable measurement over a long period of time. This has the additional advantage that a calibration or gauging need be performed less frequently. This increases the utility of the carrier according to the invention and additionally reduces maintenance costs.

Use of the carrier according to the invention for determining a weight measurement of the load or loads enables goods to be displaced in efficient manner, wherein a weight measurement is simultaneously performed. This renders a separate weighing of the goods unnecessary. During the displacement it is also possible to check whether the goods are complete and that no parts thereof are for instance missing. It is further possible to detect overloading of the carrier and preferably take appropriate action in such an event, such as an alarm and/or blocking action. This increases the safety of working with the carrier.

According to the invention, an effective weight measurement can be performed in that there is direct or indirect contact between the load or loads and the optical fiber cable at said measuring points. The most direct measurement of the weight possible is hereby obtained. This increase the accuracy and reliability of the weight measurement.

In a preferred embodiment according to the invention two or more measuring points are provided on the carrier.

Providing two or more measuring points prevents dependency on the positioning of the load or loads on the carrier. A reliable measurement can be obtained irrespective of the positioning.

A further advantage of using two or more measuring points in the carrier, in combination with the use of the optical fiber cable, for performing the weight measurement is that the measuring points are mutually connectable by means of a single cable, making it possible to provide a plurality of measuring points on the carrier part with one cable. This prevents each measuring point having to be provided with a separate cable, which would entail additional costs and could additionally result in weakening of the carrier part. The invention therefore enables an effective measurement wherein the strength and robustness of the carrier are preserved.

In embodiment according to the invention at least three measuring points are preferably provided, wherein these three or more measuring points are positioned at least partially outside a single straight line. Not arranging the individual measuring points in one line enables the load over the surface of the carrier part to be determined in effective manner. This makes the weight measurement less dependent on a correct positioning of the load or loads on the carrier part. This therefore increase the accuracy and reliability of the measurement.

In an advantageous preferred embodiment according to the invention the carrier part is provided with a groove or recess in which the optical fiber cable is at least partially receivable.

Providing a groove or recess in the carrier part enables the optical fiber cable to be largely or even wholly concealed in the carrier part. Owing to the limited dimensions of the optical fiber cable, the carrier part is hereby weakened to very limited extent. The risk of damage to the optical fiber cable is also reduced, whereby a robust measurement of the weight of the load or loads on the carrier part is obtained.

The optical fiber cable is optionally provided wholly internally in the carrier part, for instance in a channel arranged in the carrier part of the carrier. This provides even better protection for the optical fiber cable and thereby increases the robustness of the weight measurement.

In a further preferred embodiment according to the invention the carrier comprises a U-profile or tube profile.

Providing a U-profile or tube profile enables the optical fiber cable for the weight measurement to be arranged in effective manner, for instance also in the case of application in existing conventional forks of a fork-lift truck. This increases the utility of a carrier according to the invention in that it can also be applied in already existing lifting devices applied in practice.

The profile is preferably provided wholly or at least partially over a fixed fork part. The profile has the additional advantage that the reliability and accuracy of the weight measurement can be further increased. This is especially the case when performing a weight measurement on a load or loads which are not completely rigid, which may have an adverse effect on a weight measurement. By using a profile part in such a case a reliable and accurate weight measurement can still be obtained.

In an advantageous embodiment the carrier part is provided with a contact element configured to make contact with the optical fiber cable when the carrier part is loaded.

Providing the carrier part with a contact element enables the optical fiber cable to be positioned well-protected in a groove, recess, this also including a channel or cavity or the like, of the carrier, and enables indirect contact to be made with the load or loads on the carrier part in targeted manner via the contact element. The contact element is here preferably configured to realize this contact at the position of a measuring point, whereby a reliable weight measurement can be obtained in effective manner. Such a contact element can for instance be provided in an embodiment wherein the optical fiber cable is arranged in a groove or recess in the carrier part and the contact element provides for the actual contact with the optical fiber cable. In another embodiment, in which use is made of a U-profile or tube profile, the contact element makes contact with the optical fiber cable, which is arranged in or on said profile and/or fixed fork, when loaded. It is noted that the contact element can also function as a type of spacer which enables movement between a profile and the carrier part, wherein such a movement enables a measurement via contact with the optical fiber cable.

In a currently preferred embodiment the optical fiber cable is provided on the carrier. In this embodiment use is preferably made of an above stated profile which makes contact with the optical fiber cable when loaded, such that a weight measurement can be performed. When this contact is being made, use is optionally made of one or more contact elements already discussed above. Additionally or alternatively, the optical fiber cable can be provided in or on said U-profile or tube profile. It is particularly this embodiment that is suitable for application in already existing carriers of for instance a fork-lift truck.

In a currently preferred embodiment according to the invention the optical fiber cable is connected operatively to at least one of the claws of a fork board.

Operatively connecting the optical fiber cable to at least one of the claws of the carrier, for instance a fork, enables a relative displacement between claw and carrier/fork part to be detected in effective manner. If desired, this displacement can then be converted into a measure of the load exerted on the carrier. In a possible preferred embodiment according to the invention an upper claw of for instance a fork is applicable in the determining of the vertical load, and the lower claw of for instance a fork is simultaneously or alternatively applicable in the determining of the torque being exerted.

The carrier is preferably provided with one or more chambers for receiving one or more claws, and the optical fiber cable is preferably configured to detect a relative displacement of at least one of the claws. Using the chambers an effective measurement can be realized in a relatively protected environment.

If desired, the claws, optical fiber cable and controller with any components which may be required can be used as a unit when replaced and/or when used in existing carriers, such as forks. Such a unit can also be deemed a kit of parts and can be sold separately as system/unit.

Operatively connecting the optical fiber cable to claws of the carrier enables a measurement of the load and/or a torque to be determined in effective manner. If desired, it is also possible to use combinations of different optical fiber cables and/or longer optical fiber cables, these for instance extending to the carrier part as elucidated above. Such a combination enables an even more accurate measurement.

In a further embodiment according to the invention the carrier part is provided with an extension part.

Providing an extension part also makes the carrier according to the invention applicable for for instance an extending fork for a fork-lift truck. This increases the flexibility of a carrier according to the invention still further. Such an extension part can be provided with a weight measurement with an optical fiber cable in effective manner, for instance by providing sufficient play in the cable here, thus enabling extension of the fork. The flexibility of an optical fiber cable makes it possible to extend the carrier using such an extension part, while a reliable weight measurement is still possible. This provides additional functionality, which cannot be realized with conventional weighing forks.

In a further advantageous embodiment according to the invention the carrier comprises a transmitter configured to transmit one or more measurements to a controller, and an energy source connected operatively to the transmitter.

Using a transmitter it is possible to send obtained measurements to a controller, for instance wirelessly. Such a controller can for instance be provided in the cab of a lifting device such as a fork-lift truck. Alternatively or additionally, it is also possible to provide the controller in a tablet, mobile phone, watch of a driver or user of the lifting device, and to transmit the obtained measurement to a central control system, for instance in an operator room of a logistical centre. The controller is optionally provided with the software whereby the actual weight measurement can be performed. Additionally, any subsequent actions can be determined hereby, including recording the displaced goods, checking the displaced goods, monitoring overloading of the carrier, and so on.

In a further advantageous embodiment according to the invention the carrier comprises an alarm for indicating overloading of the carrier.

Providing an alarm enables a signal to be generated an overload is detected, such that a user or operator takes action and reduces the load or loads for the carrier. This can for instance also be performed using software, by halting the lifting device, for instance an AGV, until overloading has been removed. This increases the lifespan of the carrier. This also ensures the safety of working with the carrier according to the invention.

In such an embodiment the energy source is used to transmit the preferably wireless signal. This can optionally be charged in wireless manner. Such charging is for instance possible using a so-called piezo-element which, if desired, can generate energy in combination with the load or loads on the carrier, and/or using an inductive charging process. If desired, it is also possible to provide the energy source as an accumulator or battery, optionally chargeable with a cable and/or connected to the battery of the lifting device, wherein this battery can function as energy source. In a currently preferred embodiment the energy source is provided in or on the carrier.

The invention further relates to a fork board for a lifting device, such as a fork-lift truck, comprising:
an optical fiber cable arranged in or on the fork board; and
an optical fiber controller which is operatively connectable to the optical fiber cable and is configured to perform a measurement with the optical fiber cable, such that the weight of the load or loads on a carrier connected to the fork board can be determined.

Such a fork board provides similar advantages and effects as described for the carrier.

Such a fork board enables a weighing, particularly a weight measurement, to be performed with the fork board. This has the advantage that the carrier is easily replaceable without this affecting the fork board with which the measurement can be performed. This is particularly advantageous since wear occurs particularly on the carrier part, and the fork board is usually usable for the course of the lifespan of the lifting device without any significant wear.

It is noted that the various aspects of embodiments of the carrier are also applicable for the fork board. These are for instance the aspects of the various dependent claims, both individually and in any combination.

In an advantageous embodiment according to the invention at least one hook element is provided which can connect the carrier to a fork board, wherein the at least one hook element is provided with the optical fiber cable.

In an advantageous embodiment according to the invention the fork board is provided with a carrier in an embodiment according to the invention. The optical fiber cable can here be provided in or on the fork board and/or carrier part.

The invention further relates to a lifting device, such as a fork-lift truck, comprising a fork board and/or carrier part according to the invention.

Such a lifting device provides similar advantages and effects as described for the carrier and/or fork board. The lifting device is particularly a fork-lift truck or pallet truck. The lifting device can also relate to above stated types of lifting device.

The invention further relates to a method for performing a weight measurement of a load or loads on a carrier, such as a fork for a lifting device, wherein the method comprises the following steps of:
providing a carrier and/or fork board in an embodiment according to the invention; and
performing the weight measurement.

Such a method provides similar advantages and effects as described for the fork, fork board and/or lifting device provided therewith. It is hereby particularly possible to provide safe use of the carrier according to the invention and, if desired, obtain additional information.

In an advantageous embodiment according to the invention the method further comprises of detecting an overload with a controller. Hereby, an overload can be detected and a signal is generated to a user, driver or operator, preferably using the step of generating an alarm notification. If desired, it is also possible to use the alarm notification to intervene in the lifting device using software, for instance by halting the lifting device, such as an ATV, in such a situation or to prevent that the lifting device can be displaced. In this latter case the alarm notification functions as a type of immobilizer.

In a further embodiment according to the invention the method further comprises the step of detecting a preventive maintenance moment or maintenance interval. Such a detection is made possible by tracking the load in time and determining when a determined threshold is exceeded and maintenance is required. This also further increases the safety of use of the carrier according to the invention.

Further advantages, features and details of the invention are elucidated on the basis of preferred embodiments thereof, wherein reference is made to the accompanying drawings, in which:

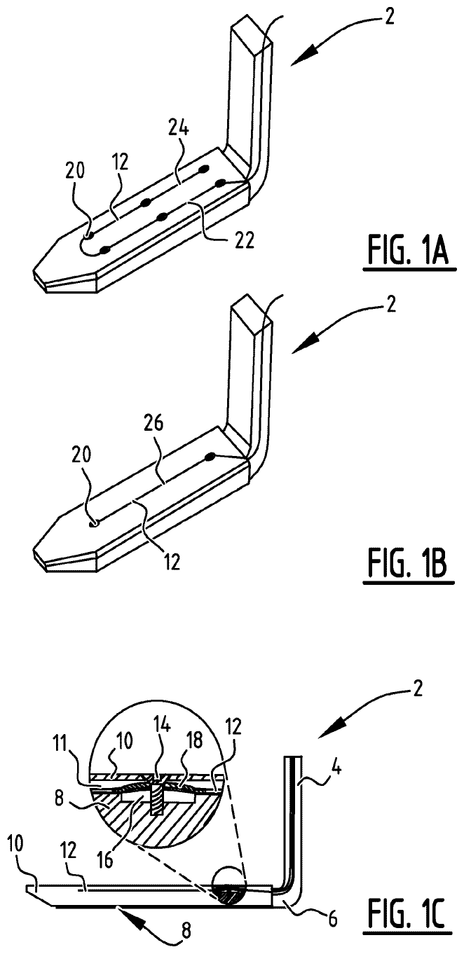

FIGS. 1A-C show a first embodiment of a carrier according to the invention;

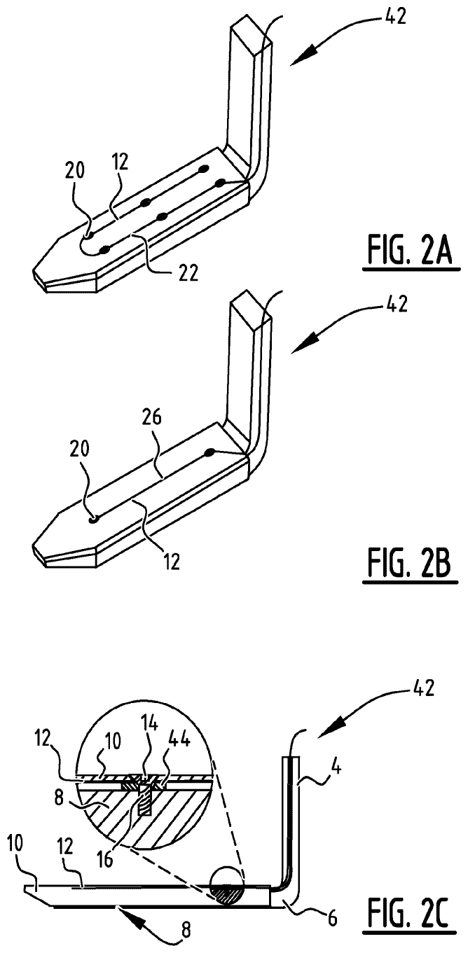

FIGS. 2A-C show a second embodiment of a carrier according to the invention;

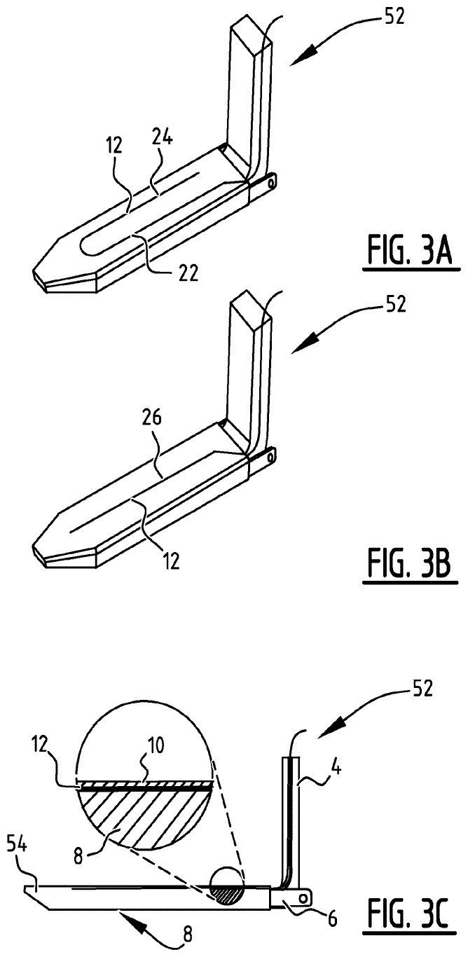

FIGS. 3A-C show views of a third embodiment according to the invention;

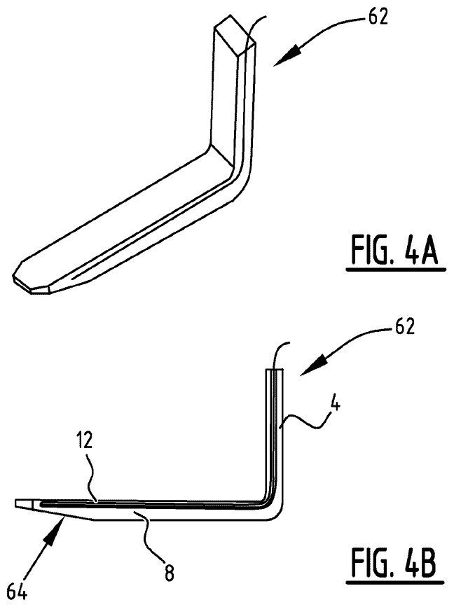

FIGS. 4A-B show views of a fourth embodiment of the carrier according to the invention;

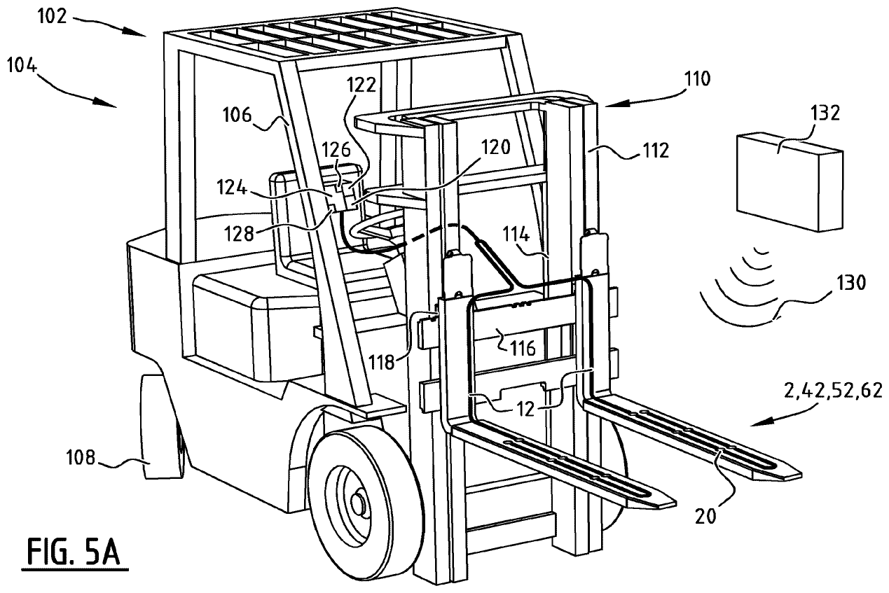

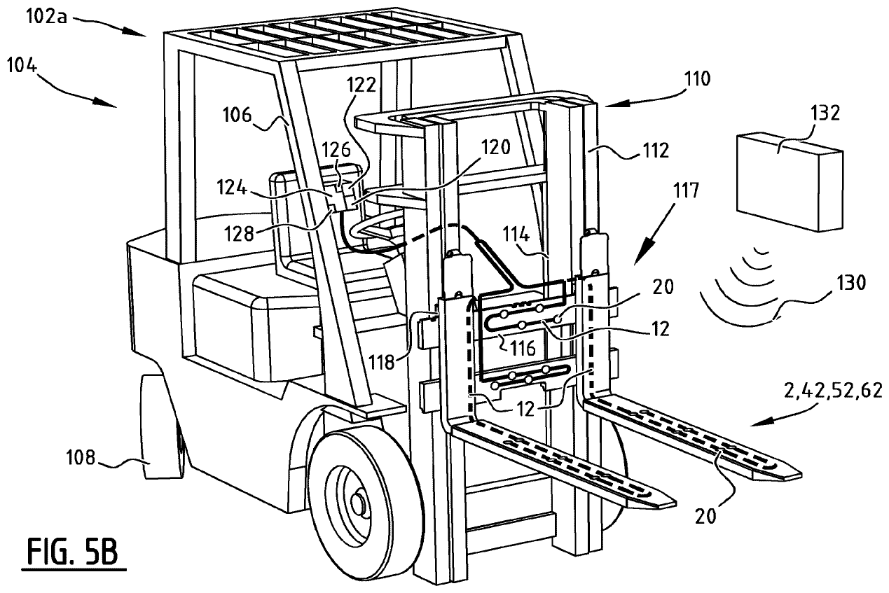

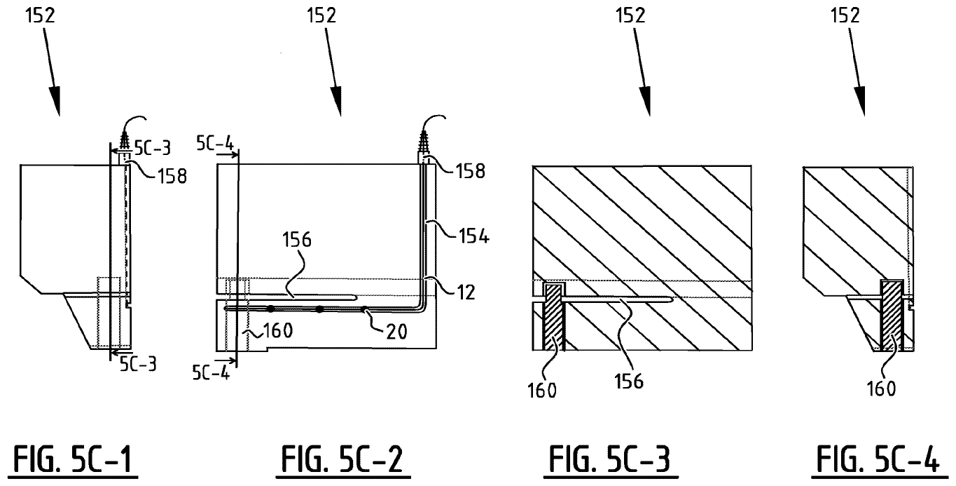

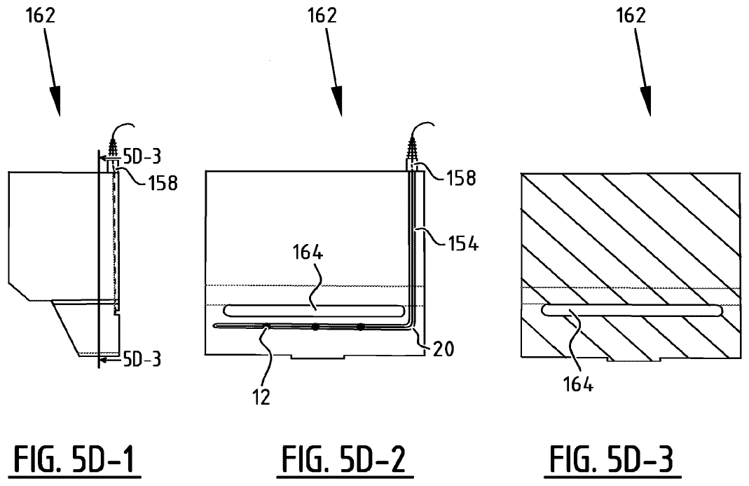

FIG. 5A shows a view of a fork-lift truck provided with the carrier in an embodiment according to the invention;

FIG. 5B shows a view of a fork-lift truck in an alternative embodiment;

FIG. 5C 1-4 and 5D 1-3 show embodiments of hooks for connection of a carrier to a fork board of a fork-lift truck;

FIG. 5E shows a view of an alternative embodiment of a fork-lift truck with the hooks of FIG. 5C and 5D;

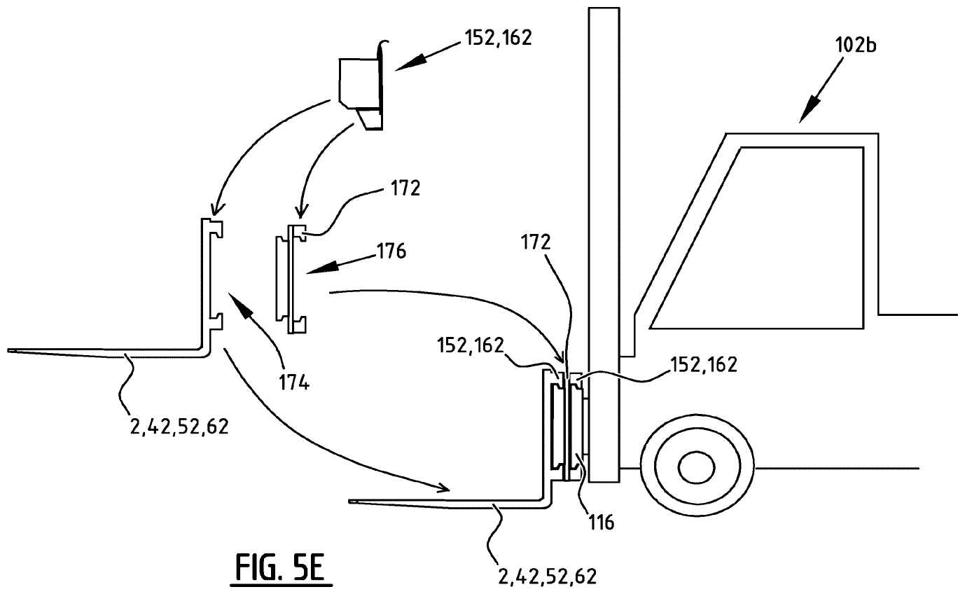

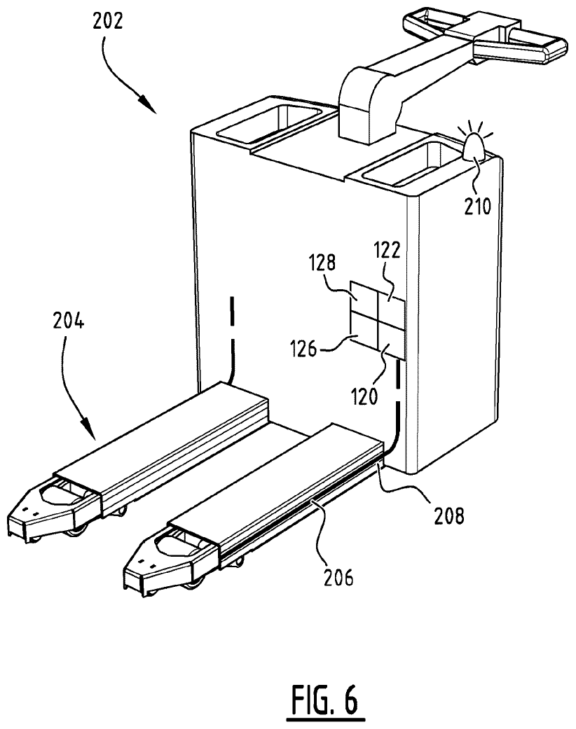

FIG. 6 shows a view of a pallet truck provided with a carrier according to the embodiment according to the invention;

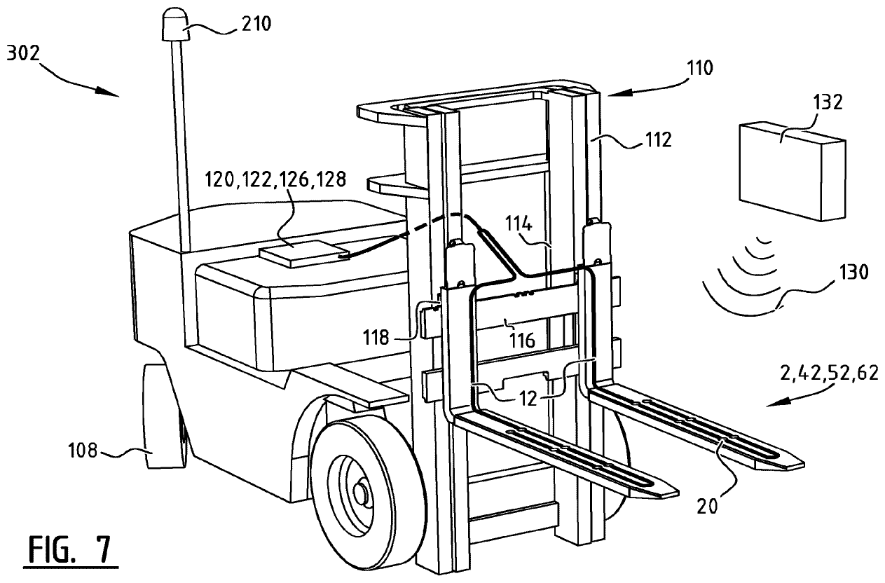

FIG. 7 shows a view of an AGV provided with a carrier according to an embodiment according to the invention; and

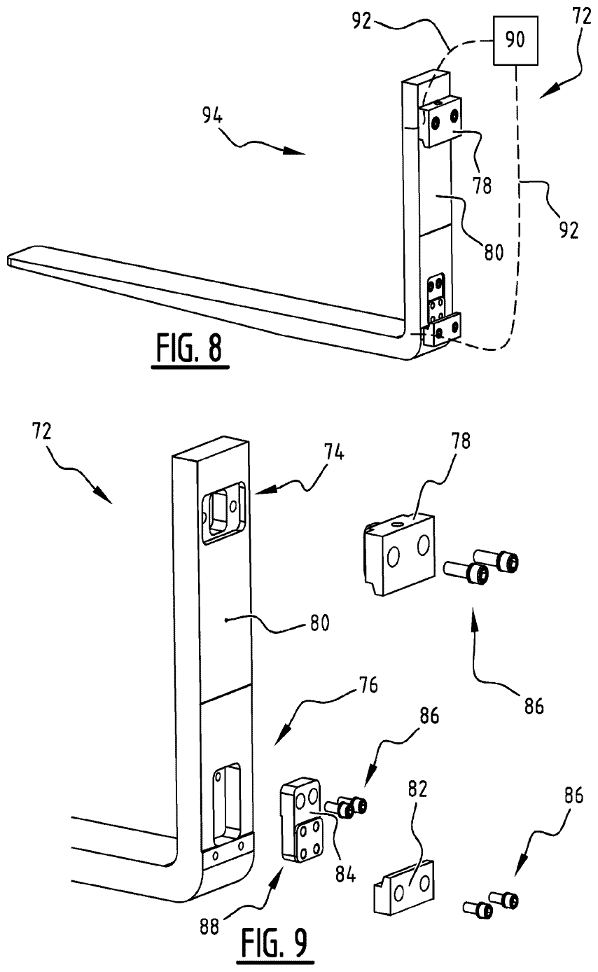

FIGS. 8 and 9 show views of a further embodiment of a carrier according to the invention.

In the shown embodiment carrier 2 (FIGS. 1A-C) is represented as a fork for a fork-lift truck and provided with a vertical fork part 4 which extends substantially vertically in use and which transposes close to the underside via bend/heel/transition 6 into a fixed fork part 8 which extends substantially horizontally in use. In this shown embodiment tube profile 10 is screwed over fixed fork part 8. Optical fiber cable 12 is provided in intermediate space 11 formed between tube 10 and fixed fork part 8. Profile 10 is connected with bolt 14 to fixed part 8 at the position of recess 16 arranged in fixed fork part 8. In this shown embodiment contact element 18 is arranged between optical fiber cable 12 and tube profile 10.

During use of carrier 2, tube profile 10 will yield to some extent when loaded, whereby contact element(s) 18 is/are pushed in and will thereby exert pressure on optical fiber cable 12. The optical signal through optical fiber cable 12 will distort to some extent due to this pressure on optical fiber cable 12. The distorted signal is then used in the weight measurement of the load or loads present on carrier 2.

Optical fiber cable 12 is for instance provided looped in order to interconnect measuring points 20 lying along two rows 22, 24 (FIG. 1A) as seen in longitudinal direction of carrier 2. In an alternative embodiment measuring points 20 are arranged along a single line 26 (FIG. 1B). It will be apparent that other alternative configurations of measuring points 20 can also be provided on carrier 2.

In a further alternative embodiment carrier 42 (FIGS. 2A-C) is provided in largely the same way as carrier 2 shown in FIGS. 1A-C. A difference is formed by contact element 44, wherein carrier 42 forms a connection between profile 10 and fixed fork part 8, wherein optical fiber cable 12 lies between contact element 44 and profile 10. A recess 16 can hereby be dispensed with. In this shown embodiment contact element 44 serves mainly to realize a distance between carrier 42 and profile 10, whereby profile 10 is able to bend to some extent relative to carrier 42, whereby optical fiber cable 12 is deformed to some extent and a usable measurement signal is obtainable. Alternatively, it is also possible to arrange optical fiber cable 12 on the underside of contact element 44.

In a further alternative embodiment carrier 52 (FIGS. 3A-C) is likewise provided with similar components as described for carriers 2, 42. Carrier 52 is however an (extending) fork with extending tube 54 which is therefore able to displace relative to fixed fork part 8 over a longitudinal direction thereof and can optionally be fixed at a desired position. It will be apparent that the invention is similarly also applicable to extending forks wherein the length of the fork is adjustable, for instance in accordance with the loads to be picked up and displaced. Optical fiber cable 12 is here arranged directly between profile 10 and fixed fork part 8, optionally wholly or partially in a groove or channel provided in profile 10 and/or fixed fork part 8. Optical fiber cable 12 is further provided with sufficient clearance to be able to co-displaced with profile 54 of the extending fork in order to thereby obtain a sufficiently reliable weight measurement over the carrying surface.

In yet a further alternative embodiment carrier 62 (FIGS. 4A-C) is provided with similar components as described for carriers 2, 42, 52. Carrier 62 is provided with optical fiber cable 12 which is arranged in fixed fork part 8, preferably in a groove or channel 64 therein. A compact carrier 62 with a limited number of parts is hereby provided.

Carrier 62 makes use of the deformation of carrier part 8 when determining the weight measurement. Specific measuring points 20 can be provided if desired, for instance as shown in other embodiments. Additionally or alternatively, specific measuring points 20 can be provided for carrier 52 at any desired position.

In the shown embodiment the carrier part according to the invention is formed by tube 10 for carrier 2, 42, 52 and fixed part 8 for carrier 62.

Fork-lift truck 102 (FIG. 5A) is provided with cab 104, frame 106 and a number of wheels 108. Provided on front side 110 of fork-lift truck 102 is mast construction 112. In the shown embodiment mast construction 112 is provided with two guides 114 in which or on which fork board 116 is arranged. Carrier 2, 42, 52, 62 according to the invention is arranged on fork board 116 by means of coupling means 118. In the shown embodiment optical fiber cable 12 is run schematically from fork 2, 42, 52, 62, over mast construction 112 and to interrogator 120, which sends an optical signal through optical fiber cable 12 and then receives a return signal. It will be apparent that optical fiber cable 12 can be run over or along mast construction 112 in diverse ways.

In the shown embodiment interrogator 120 is provided integrated with software module 122 configured to determine the weight of the load or loads on carrier 2, 42, 52, 62 on the basis of the return signal received by interrogator 120. In the shown embodiment display 124 is likewise provided in integrated manner. A notification of the weight measurement can be provided on display 124, as can a signal in the event of a detected overload, for instance as an alarm notification.

Also provided is energy source 126, in the shown embodiment integrated with interrogator 120, software 122 and display 124. Optionally provided is transmitter 128, with which it is possible to wirelessly transmit signals 130 to external control system 132, for instance an ERP system. In this schematically shown embodiment software 126 determines inter alia the alarm and optionally checks whether all goods are being or have been displaced. It will be apparent that, if desired, a separate alarm can be provided. It is also possible to provide components in, at or close to carriers 2, 42, 52, 62, for instance interrogator 120, and optionally software 122 with transmitter 128 and energy source 126. Additionally or alternatively, signals 130 can also be sent to a tablet, telephone or watch of a driver or other operator.

When performing a weight measurement, interrogator 120, fed by energy source 128, sends an optical signal through optical fiber cable 12. If no load is present on carrier 2, 42, 52, 62, the optical signal will be received in return by interrogator 120 unimpeded. If a load or a plurality of loads is/are present on carrier 2, 42, 52, 62, optical fiber cable 12 will deform to some extent, optionally with interposing of contact element 18, 44, causing the optical signal to be impeded and to be received in return by interrogator 120 somewhat distorted. Using software 122 the return signal can converted into an actual weight measurement and, if desired, be displayed via display 124. The weight measurement can optionally be sent via transmitter 128 to other systems, such as ERP system 132, via wireless signal 130.

Overloading can optionally be detected using software/controller 122. An alarm notification can further optionally be generated on the basis of such a detected overload. Such an alarm notification, as well as the weight measurement, can be displayed on display 124 or be passed on to external systems, for instance the ERP system 132, via wireless signal 130. A preventive maintenance moment or maintenance interval can optionally be detected with software/controller 122 and/or external system 132. Software/controller 122 or external system 132 can further function as immobilizer in order to prevent lifting device 102 from moving in the event of an overload.

Fork-lift truck 102a (FIG. 5B) is provided with alternative sensor system 117, wherein optical fiber cable 12 and measuring points 20 are provided in or on fork board 116. In this shown alternative embodiment fork-lift truck 102a is provided with the same or similar components as described for fork-lift truck 102 (FIG. 5A). Fork-lift truck 102a (FIG. 5B) is optionally provided with sensor system 117, wherein optical fiber cable 12 and measuring points 20 are provided in or on both fork board 116 and carrier 2, 42, 52, 62.

Fork-lift truck 102a with alternative sensor system 117 enables a weighing to be performed with the fork board. This has the advantage that carrier 2, 42, 52, 62 is easily replaceable without this affecting the sensor system and measurement.

Carrier 2, 42, 52, 62 is connectable to fork board 116 with hook 152 (FIG. 5C 1-4). Hook 152 can here be arranged on or in carrier 2, 42, 52, 62 or on fork board 116. Hook 152 is provided with channel 154 for optical fiber cable 12 and measuring points 20. In the shown embodiment hook 152 is further provided with recess 156, whereby some deformation of hook 152 is possible and the load on hook 152 is detectable with optical fiber cable 12. Use is made here of the measuring system 158 connected (operatively) to channel 154 and optical fiber cable 12. In the shown embodiment rod or pin 160 is optionally arranged in order to prevent undesired deformation, including undesired torsion in the lower part of hook 152.

In an alternative embodiment hook 162 (FIG. 5D 1-3) is provided in similar manner as shown above for hook 152. In this alternative embodiment hook 162 is provided with recess 164. It will be apparent to the skilled person that further alternative embodiments are likewise possible.

Fork-lift truck 102b (FIG. 5E) is provided with fork board 116 and carriers 2, 42, 52, 62, wherein (upper) hooks 152, 162 are provided. In the shown embodiment fork-lift truck 102b is optionally provided with fork board front 172 as part of fork board 116. Carriers 2, 42, 52, 62 are provided with hook-like elements 174 which are placeable on or at fork board front 172 and fork board 116. In the shown embodiment fork board front 172 is provided with hook-like elements 176 which are placeable on or at fork board 116. Hooks 152, 162 can be provided as upper elements of hook-like elements 174, 176. Additionally or alternatively, optical fiber cable 12 can be provided in carriers 2, 42, 52, 62 as shown previously. If desired, further aspects as shown and/or described for fork-lift truck 102, 102a can also be applied in fork-lift truck 102b.

Pallet truck 202 (FIG. 6) can likewise be provided with a similar carrier 2, 42, 52, 62 as shown in FIGS. 1-4 and similar components as for fork-lift truck 102. In the shown embodiment of pallet truck 202 optical fiber 206 is arranged on a side of fork 204 in groove 208 thereof. It will be apparent that the configurations as shown in FIGS. 1-4 can also be applied for pallet truck 202 and that the embodiment shown in FIG. 6 can be applied for another lifting device, such as fork-lift truck 102.

In the schematically shown embodiment of pallet truck 202 optical fiber cable 206 is operatively connected to interrogator 120, software/controller 122, transmitter 128 and energy source 126. Instead of a separate energy source 126, use can also be made of the battery of pallet truck 202. An alarm in the form of a lamp 210 is optionally shown for emitting a visual alarm signal in the event of a detected overload. It will be apparent that such a visual alarm signal 210 can also be applied for other lifting devices, such as fork-lift truck 102.

AGV 302 (FIG. 7) can also be provided with carriers 2, 42, 52, 62 in a manner similar to that shown for fork-lift truck 102. The operation thereof correspond largely with the described method for fork-lift truck 102 provided with such carriers 2, 42, 52, 62. In this shown embodiment for AGV 302 interrogator 120, software/controller 122, transmitter 128 and energy source 126 are provided on AGV 302 in integrated manner. It will be apparent that these components can also be arranged wholly or partially on carrier part 2, 42, 52, 62 as separate parts.

Carrier 72 (FIGS. 8 and 9) are shown as fork and are provided with two chambers 74, 76. Upper chamber 74 is configured to receive or accommodate upper suspension claw 78. In the shown embodiment claw 78 is embodied as separate part usable in back 80 of carrier/fork 72. Lower chamber 76 is configured to receive or accommodate, or otherwise connect to, lower suspension claw 82. In the shown embodiment claw 82 is couplable/connectable to insert 84 which is placeable in or on lower chamber 76. In the shown embodiment the different parts are mutually connected with a screw connection 86. It will be apparent that other connections are also possible, for instance welding. The advantage of screw connection(s) 86 is ease of maintenance, assembly and replacement of worn parts. Such wear can have various causes, including shifting of forks/carriers 72 on a fork board. Screw connection 86 further enables parts to be switched over to another fork-lift truck.

Carrier 72 with chambers 74, 76 and claws 78, 82 can be used to determine load and/or deformation of carrier 72. It is hereby particularly possible to uncouple the deformation of fork back 80 when carrier 72 is loaded from the deformation of parts 78, 82, 84 in chamber 74, 76. This results in a “displacement” between fork back 80 and upper claw 78/insert 80 which can be measured with measuring instrument 90 (shown schematically in FIGS. 8 and 9) by “deformation” of optical fiber cable 92 (shown schematically in FIGS. 8 and 9) in a manner similar as already described above for the other embodiments. Measuring instrument 90 is for instance provided with interrogator 120, software/controller 122, transmitter 128 and energy source 126 as shown above. Such a construction with chambers 78, 82 further preferably provides space for attachment of optical fiber cable 92, and any associated (mechanical) amplifiers (not shown).

If desired, it is possible to use measuring instrument 90, cable 92, (chambers 74, 76), claws 78, 82 and optionally insert 80 together as a unit (in the manner of a kit of parts) to replace and/or for use in existing carriers.

In the shown embodiment upper claw 78 is preferably intended to measure the vertical component of the load exerted on carrier 72. Insert 80, in assembled state behind lower claw 82, is preferably intended to measure the torque of the load. Combined, the two measurements can preferably provide sufficient data to determine weight of the load, centre of gravity of the load and for instance overloading. Insert 80 is preferably provided with optional slide strip 88 to limit wear/loss due to friction. Additionally or alternatively, this could also be solved in other manner, for instance using a roller, ball bearings, and so on. Strip 88 is preferably replaceable, this in respect of wear inflicted by the fork-lift truck forks sliding reciprocally over a fork board in order to adjust the width dimension of the fork-lift truck forks for different pallet sizes.

It will be apparent that carrier 72 can also be applied for fork-lift truck 102, pallet truck 202, and AGV 302.

It will further also be apparent that components of various shown embodiments are mutually interchangeable and/or applicable in other possible embodiments according to the invention.

The present invention is by no means limited to the above described preferred embodiments thereof. The rights sought are defined by the following claims, within the scope of which many modifications can be envisaged.

1. A carrier for loads, such as a fork for a lifting device, comprising:
coupling means configured to couple the carrier to the lifting device;
a carrier part for carrying loads,
an optical fiber cable arranged in or on the carrier part; and
an optical fiber controller which is operatively connectable to the optical fiber cable and is configured to perform a measurement with the optical fiber cable, such that the weight of the load or loads on the carrier can be determined.

2. The carrier according to claim 1, wherein two or more measuring points are provided on the carrier.

3. The carrier according to claim 2, wherein at least three measuring points are provided on the carrier and wherein the three or more measuring points are positioned at least partially outside a single line.

4. The carrier according to claim 1, wherein the carrier part is provided with a groove or recess in which the optical fiber cable is at least partially receivable.

5. The carrier according to claim 1, further comprising a U-profile or tube profile.

6. The carrier according to claim 1, wherein the carrier part is provided with a contact element configured to make contact with the optical fiber cable when the carrier part is loaded.

7. The carrier according to claim 1, wherein the optical fiber cable is provided on the carrier.

8. The carrier according to claim 1, wherein the optical fiber cable is provided in or on the U-profile or tube profile.

9. The carrier according to claim 1, wherein the optical fiber cable is connected operatively to at least one of the claws of a fork board.

10. The carrier according to claim 9, wherein the carrier is provided with one or more chambers for receiving one or more claws, and the optical fiber cable is configured to detect a relative displacement of at least one of the claws.

11. The carrier according to claim 1, wherein the carrier part is provided with an extension part.

12. The carrier according to claim 1, further comprising a transmitter configured to transmit one or more measurements to a controller, and an energy source connected operatively to the transmitter.

13. The carrier according to claim 1, further comprising an alarm for indicating overloading of the carrier.

14. A lifting device such as a fork-lift truck, comprising a fork board, the fork board comprising:
an optical fiber cable arranged in or on the fork board; and
an optical fiber controller which is operatively connectable to the optical fiber cable and is configured to perform a measurement with the optical fiber cable, such that the weight of the load or loads on a carrier connected to the fork board can be determined.

15. The lifting device according to claim 14, further comprising a carrier comprising:
coupling means configured to couple the carrier to the lifting device; and
a carrier part for carrying loads, wherein the optical fiber cable arranged in or on the carrier part.

16. The lifting device according to claim 15, further comprising at least one hook element, wherein the at least one hook element is provided with the optical fiber cable.

17. (canceled)

18. A method for performing a weight measurement of a load on a carrier, such as a fork for a lifting device, comprising the steps of:
providing a carrier or lifting device with a fork board, the carrier comprising:
coupling means configured to couple the carrier to the lifting device;
a carrier part for carrying loads;
an optical fiber cable arranged in or on the carrier part; and
an optical fiber controller which is operatively connectable to the optical fiber cable, wherein the optical fiber controller is configured to perform a measurement with the optical fiber cable such that the weight of the load or loads on the carrier can be determined; and
performing a measurement.

19. The method according to claim 18, further comprising one or more of the steps of detecting an overload with a controller, generating an alarm notification, and detecting a preventive maintenance moment or maintenance interval.

20. (canceled)

21. (canceled)

22. The carrier according to claim 2, wherein the carrier part is provided with a groove or recess in which the optical fiber cable is at least partially receivable, and wherein the optical fiber cable is connected operatively to at least one of the claws of a fork board, wherein the carrier is provided with one or more chambers for receiving one or more claws, and the optical fiber cable is configured to detect a relative displacement of at least one of the claws.

23. The lifting device according to claim 15, wherein the carrier part is provided with a groove or recess in which the optical fiber cable is at least partially receivable, and wherein the optical fiber cable is connected operatively to at least one of the claws of a fork board, wherein the carrier is provided with one or more chambers for receiving one or more claws, and the optical fiber cable is configured to detect a relative displacement of at least one of the claws.
